(19) United States
(12) Patent Application Publication
(10) Pub. No.: US 2009/0287340 A1
(43) Pub. Date: Nov. 19, 2009

(54) In-line effluent analysis method and apparatus for CMP process control

(75) Inventors: Stephen J. Benner, Lansdale, PA (US); Darryl W. Peters, Stewartsville, NJ (US)

Correspondence Address: WENDY W. KOBA, PO BOX 556, SPRINGTOWN, PA, 18081, US

(73) Assignee: Confluense LLC

(21) Appl. No.: 12/454,201

(22) Filed: May 14, 2009

Related U.S. Application Data
(60) Provisional application No. 61/127,798, filed on May 15, 2008.

(51) Int. Cl. G06F 17/00

(52) U.S. Cl. 700/110; 700/121; 700/109

(57) ABSTRACT

An apparatus and method for collecting and analyzing the effluent stream created by a chemical mechanical planarization (CMP) process performs a continuous measurement of at least one effluent characteristic and integrates the results over time to create a volumetric analysis of the planarization process. The volumetric analysis can be used as feedback/feedforward signals to control the planarization process itself (e.g., endpoint detection based upon an known initial thickness of film material), create alarm signals for out-of-range measurements, and/or waste stream indicators useful in treating the effluent prior to discharge (e.g., determining a pH correction).

### CROSS-REFERENCE TO RELATED APPLICATION

This application claims the benefit of U.S. Provisional Application No. 61/127,798, filed May 15, 2008.

### TECHNICAL FIELD

The present invention relates to the field of chemical mechanical planarization (CMP) of semiconductor wafers and, more particularly, to an in-line system for providing volumetric analysis of removed effluent for feedback and feedforward control of the planarization process.

### BACKGROUND OF THE INVENTION

A process known in the art as chemical mechanical planarization (CMP, including electro-CMP or eCMP) has evolved as a preferred technique for planarizing a semiconductor wafer surface. CMP involves the use of a polishing pad affixed to a polishing table, with a separate holder used to present the semiconductor wafer against the rotating polishing pad. A polishing slurry containing either or both abrading particulates and chemical additives is dispensed onto the surface of the polishing pad and used to carefully remove irregularities from the wafer surface (i.e., “planarizing” the surface). The abrading particulates provide for the mechanical aspect of the planarization process, while specific chemical additives are used to selectively oxidize or etch the film material, softening or aiding its removal from the wafer surface.

In certain situations, wafer planarization is required after a relatively thick layer of a material (a “relatively thick” material generally comprising either a ‘fill’ dielectric material or an ‘overburden’ conductive material) has been deposited over a patterned surface containing a number of raised device regions and associated troughs (such as, for example, pre-metal dielectric (PMD) layer deposition or inter-layer dielectric (ILD) deposition, or deposition of a conductive material over a patterned (etched) dielectric layer). FIG. 1 illustrates this situation in simplified form, showing a relatively thick layer 1 deposited over a wafer surface 2 including a device region 3. Inasmuch as layer 1 will form a conformal coating, top surface 4 of layer 1 will follow the contour of the step created by the presence of device region 3. The purpose of applying a CMP process, in this case, is to remove only a predetermined portion of layer 1 so as to re-planarize the wafer and allow for further processing to be performed on a planar surface (indicated by dotted line “S” in FIG. 1). Using a CMP (or eCMP) process in these instances is referred to at times as a “blind” process (or a stop-in-film process), since there are no interface markers that may be used as indicators for detecting the endpoint of the removal process. The overall performance of this type of planarization is therefore dependent on factors such as consistent removal rate (both within-die removal rate and within-wafer removal rate) and lot-to-lot uniformity.

When the step difference, shown as Δs in FIG. 1, is removed by using a conventional CMP process, the degree of achieved planarity (referred to as “step height reduction efficiency”) significantly depends on polishing pad properties. In addition to the step difference, factors such as device pattern layout, film deposition characteristics, characteristics of the slurry (including slurry ‘film’ thickness, concentration, distribution) and non-uniformity in the polishing equipment will all impact the degree of planarity achieved in a CMP process.

While the illustration of FIG. 1 shows the topography associated with a single “feature” in a layer (a “local” planarity problem), the inclusion of a large number of separate and differently-shaped elements across a wafer surface results in creating a large number of local feature elements, ultimately requiring a “global” planarization solution to restore an acceptable lithographic depth of field.

Another challenge for chemical mechanical planarization processes, especially with respect to conductive interconnects, is to remove conductive material “overburden” without causing excessive dishing of the conductive material in the trenches. Similarly, a typical requirement is to have minimal erosion and oxide loss in areas that cannot withstand aggressive CMP due to the composite density of fine metal trenches and vias in the surrounding oxide or low-K dielectric layer.

FIGS. 2(a) and 2(b) are exemplary schematic diagrams illustrating dishing and erosion, respectively. Dishing occurs when a top surface of a copper trench/via line 5 recedes below the level of adjacent dielectric 6, illustrated by reference “d” in FIG. 2(a). Erosion is a localized thinning of dielectric 6, illustrated by reference “e” in FIG. 2(b). Erosion of the dielectric occurs during the final phases of polishing (overpolish), which is generally necessary to make sure that all the metal is removed from the top of the dielectric (otherwise lines may be shorted together). Dishing occurs on a soft metal, e.g., copper, inasmuch as the chemically-softened material will be removed at a faster rate during the overpolish step than the surrounding oxide or barrier metal, which are both harder materials. Through dishing, the thickness of copper lines 5 may be reduced, which increases the electrical resistance and may cause downstream contact problems with subsequent interconnects. In addition, the overall changes in the planarity caused by dishing and erosion can also lead to challenges in obtaining good focus across the die during subsequent lithographic steps. For typical CMP processes, the approach generally taken is a series of planarization steps. That is, the process to achieve a planarized copper top surface and the process from the planarized copper top surface to the clearance of the copper are performed in sequential operations, each with potentially unique consumables and process conditions. A derivative of CMP, commonly referred to as electrochemical mechanical planarization or eCMP, has been developed for use, for example, for removal of bulk copper in overburden removal planarization processes. An exemplary eCMP process creates an electrochemical cell between the wafer and the polishing pad with the abrasive slurry interposed between the wafer and the polishing pad.

Modern CMP equipment has evolved to providing for multi-step polishing sequences (using, for example, 2-4 different platens), allowing for partial polishing methods (steps) to be employed. One problem with this approach, however, is that it is difficult to control the removal rate and endpoint for each of the steps, since the starting condition may be irregular and the target ‘step endpoint’ may be inter-layer, or beyond a transition (i.e., overpolish).

### SUMMARY OF THE INVENTION

The needs remaining in the prior art are addressed by the present invention, which relates to the field of chemical mechanical planarization (CMP and eCMP) of semiconductor wafers and, more particularly, to an in-line system for providing volumetric analysis of removed effluent for feedback and/or feedforward control of the planarization process, including treatment of the waste stream from the process.

In accordance with the present invention, an algorithmic determination of a volume or flow of removed material is analyzed to determine current system conditions and provide feedback and/or feedforward control of the CMP process. The removed material, hereinafter referred to as “effluent”, generally comprises the following components: polishing slurry, water, wafer debris, chemically-reacted material from the wafer surface, polishing pad debris, conditioning agents, conditioning disk debris, and the like. The various effluent analyses include, without limitation, chemical, tribological, physical and/or electrical, including various combinations thereof.

It is an aspect of the present invention that the ability to perform a real-time analysis of a volume, sample or stream of removed effluent allows for CMP step level endpointing to create an accurate planarization of a layer with improvements over various systems of the prior art. This is a particularly useful attribute in systems such as inter-layer dielectric (ILD) or pre-metal dielectric (PMD) CMP processes, where there is no physical indicator (other than time) that may be used to determine the end point of a re-planarization process. Additionally, the volumetric analysis allows for “soft-landing”/removal rate control of CMP processes associated with removing overburden or post-transition material (e.g., preventing copper dishing or erosion, as described earlier), yielding improve surface conditions (with respect to, for example, roughness, nanotopography, and the like). Moreover, the volumetric analysis of the present invention allows for continuous monitoring of the removal rate of the target film layer (e.g., dielectric, copper, or the like), creating an in-situ process for monitoring and controlling the removal rate, where feedback signals can be used to adjust the various materials/forces/speeds/eCMP current used in planarization to affect the target film removal rate.

It is a further aspect of the present invention that the information collected by the analysis process may be used in a feedforward manner to perform waste treatment/abatement of the effluent. Post-removal treatment of effluent may be performed to prevent chemical reactions in the waste stream, create a potable waster stream, and the like. Moreover, unexpected changes in any of the volumetric analyses (e.g., sudden increase in conductivity of effluent, significant decrease in turbidity, etc.) can be used in accordance with the present invention as excursion alarms, alerting the user to problems with the CMP polishing pad (e.g., pad failure, uneven pad surface), non-uniform removal of material across a wafer surface (e.g., center fast/center slow—an emerging concern as wafer diameters increase), slurry delivery apparatus failure, and the like.

Other and further aspects and embodiments of the present invention will become apparent during the course of the following discussion and by reference to the accompanying drawings.

### BRIEF DESCRIPTION OF THE DRAWINGS

Referring now to the drawings, where like numerals represent like parts in several views:

FIG. 1 shows an exemplary wafer topology upon which the apparatus and method of the present invention may be employed;

FIGS. 2(a) and (b) illustrate the known conditions of “dishing” and “erosion”, associated with a Cu CMP process;

FIG. 3 illustrates an exemplary CMP system including an in-line volumetric effluent analysis unit of the present invention;

FIG. 4 illustrates specific topologies of a stack of layers of different materials which may be planarized using the effluent analysis unit of the present invention;

FIG. 5 is a simplified block diagram of an exemplary flow-based effluent analysis unit of the present invention;

FIG. 6 contains a plot of effluent conductivity as a function of time for a Cu CMP process;

FIG. 7 is a flowchart of an exemplary analysis process that may be used by the unit of FIG. 4;

FIG. 8 is a simplified block diagram of an exemplary volume-based effluent analysis unit of the present invention; and

FIG. 9 contains plots of effluent pH and conductivity as a function of time for a dielectric CMP process.

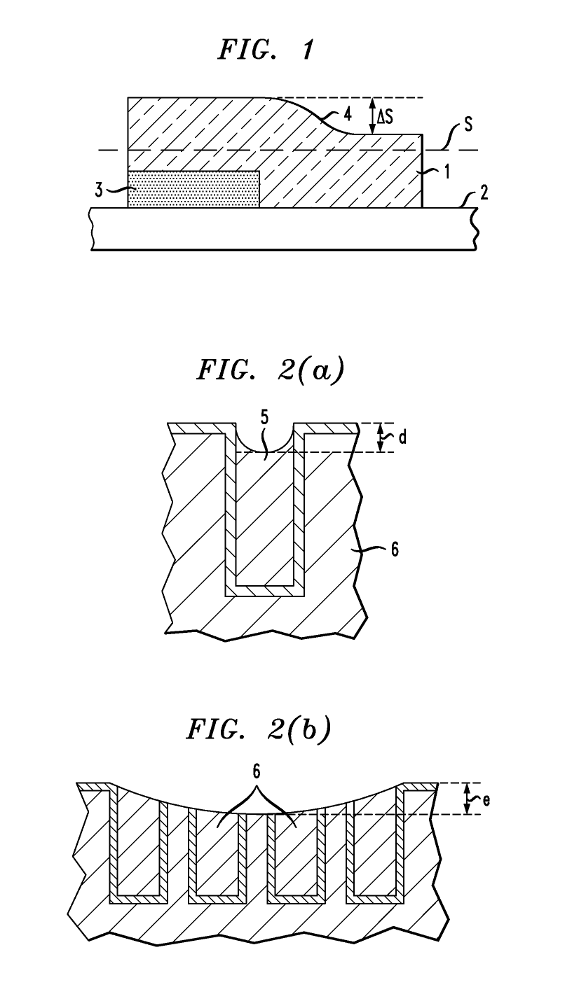

### DETAILED DESCRIPTION

In accordance with the present invention, the effluent created during planarization and conditioning in a CMP system is directed into an effluent analysis unit coupled to the CMP system. By knowing the characteristics of the film material(s) initially present on the wafer surface (e.g., thicknesses, chemical compositions), an algorithmic analysis of the removed material as present in the effluent is used in accordance with the present invention to monitor the CMP process in real time. For example, the effluent volumetric analysis of the present invention can be used to determine the endpoint of a dielectric planarization process with improved accuracy over the prior art “time interval” method. That is, rather than looking for a reflectance transition (an optical signal process based upon observations through a ‘window’ in polishing pad, the observations made on a per revolution basis) which relates to a “film clearing” end point, or relying on a timed endpoint (such as used for “blind” CMP), the system of the present invention looks for a calculated volume of film material to have been removed. When removing copper overburden, the volumetric analysis of the present invention tracks, for example, the concentration of copper in the effluent and stops the process and/or controls the removal rate of the process to provide the desired “soft landing” that avoids the dishing and erosion problems described above.

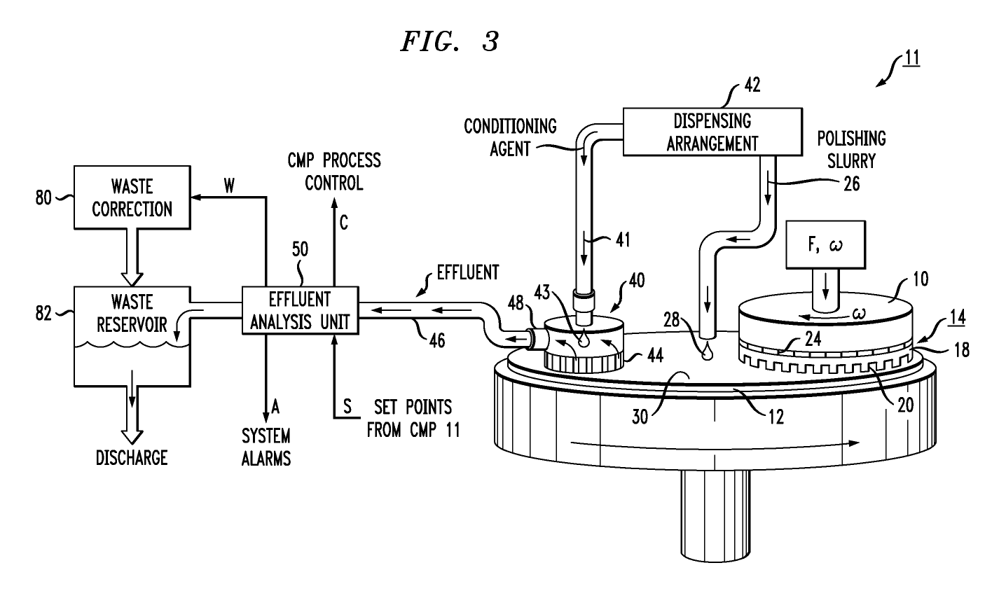

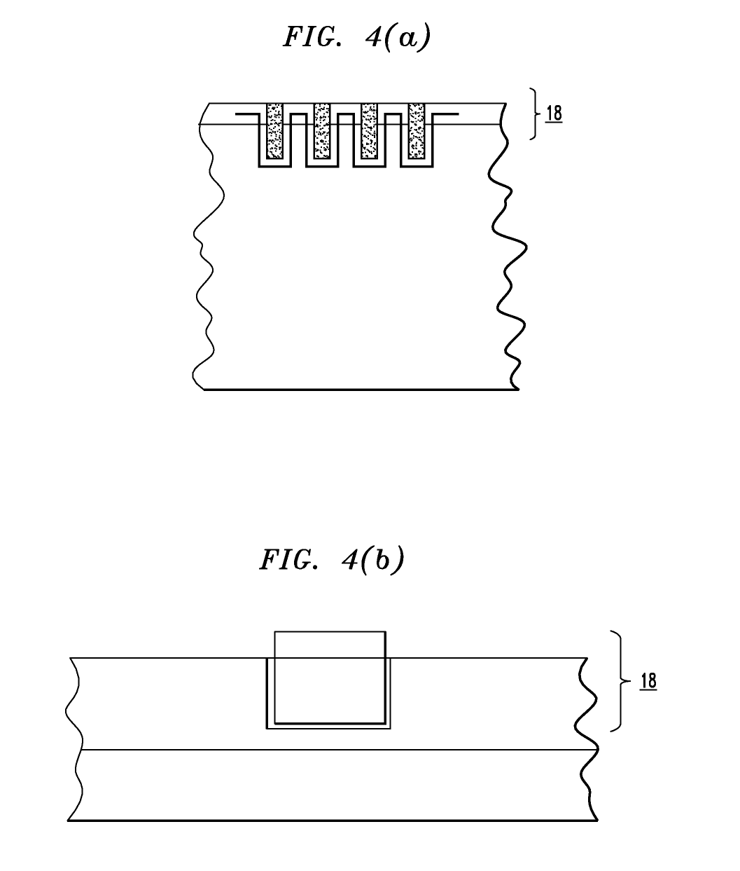

FIG. 3 illustrates an exemplary CMP system 11 within which the real-time effluent analysis of the present invention may be employed. As shown, a polishing head 10 is positioned above a polishing pad 12 of CMP system 11. A semiconductor wafer 14 is attached to bottom surface 16 of polishing head 10 and is thereafter lowered onto (moving) polishing pad 12 to initiate the planarization process. In this example, semiconductor wafer 14 is shown as comprising a thick layer 18 including a number of steps 20 in its conformal coating, where steps 20 are associated with a number of components 22 formed on a layer 24 of semiconductor wafer 14. Layer 18 may be, for example, a dielectric material or a metal (such as copper). Indeed, “layer 18” may comprise a stack of layers of different materials—dielectrics, metals, “barrier layers”, trench linings, and the like. FIG. 4 illustrates two such structures, where FIG. 4(a) shows a plurality of metal trench structures and associated barrier layer and FIG. 4(b) shows a barrier layer in conjunction with a metallic contact region and an overlying cap layer. The materials used to form the barriers and trench liners may comprise, for example, tantalum, tantalum nitride, a CoWP alloy, and the like. Obviously, the compositions of the various constituents of “layer 18” will impact the types of effluent analyses performed in accordance with the present invention.

Referring again to FIG. 3, polishing slurry dispenser 26 is used to introduce a polishing slurry 28 of a predetermined composition onto surface 30 of polishing pad 12, where polishing slurry 20 includes materials that contribute to the planarization process. That is, polishing slurry may comprise certain chemical additives that will etch away or soften exposed areas of layer 18. An abrasive particulate material of a predetermined size may be included in the slurry and used to grind away steps 20 from layer 18 in a mechanical process. Abrasive-free electrolytes (for eCMP processes), or other types of abrasive-free chemical slurries may also be used. Polishing slurry dispenser 26, in this embodiment, is shown as originating from a dispensing arrangement 42.

As is known in the prior art, various attributes of polishing head 10 and slurry 28 may be adjusted to control the planarization process. Attributes of polishing head 10 include, for example, the downforce F applied to polishing pad 12 through wafer 14 and the rotational speed ω of polishing head 10. Attributes of polishing slurry 28 include, for example, the chemical composition of the slurry, the particulate density and particle size, the temperature of the slurry, and the rate of dispensing the slurry onto surface 30 of polishing pad 12.

In accordance with the present invention, these and other attributes are studied in a removed volume of effluent to assess an on-going planarization process and control the process itself. Indeed, the volumetric analysis of the present invention may be applied in a continuous manner, monitoring the concentration of the target film in the effluent in an on-going basis, providing an in-situ removal rate monitoring and control process. As will be discussed in detail below, the analysis may be used in a feedback mode, a feedforward mode, or both.

Referring again to FIG. 3, CMP system 11 is shown as further comprising an exemplary conditioning apparatus 40 that is used to clean (“condition”) polishing pad 12 by removing spent polishing slurry 28, wafer debris and the like. Conditioning apparatus 40 includes a disk 44 which is formed of an abrasive material and preferably contains a plurality of apertures formed therethrough. Abrasive conditioning disk 44 is disposed to contact polishing pad 12 and functions to dislodge polishing debris as it collects on polishing pad surface 30, preventing “glazing” of the polishing pad surface. As is known in the art, a conditioning brush may be used in place of the abrasive disk. Conditioning agents 43, such as ultra-pure water (UPW) or other flushing liquids, gasses, or blended agents, may be dispensed onto polishing pad surface 30 by a conditioning dispenser 41. In the particular embodiment of FIG. 3, conditioning dispenser 41 is controlled by dispensing arrangement 42, in a manner similar to the control of the polishing slurry dispensing process.

In accordance with the present invention, an effluent evacuation path 46 is coupled to a vacuum outlet port 48 on conditioning apparatus 40 such that a vacuum force may be applied through evacuation path 46 and used to remove the effluent from polishing pad surface 30. In most cases, effluent evacuation path 46 will comprise a hose, tube, or the like. All are considered to fall within the scope of the present invention, where for the sake of brevity, the “path” will hereinafter be referred to as “hose 46”. In a preferred embodiment of conditioning apparatus 40, abrasive disk 44 is formed to include a number of through-holes, or apertures, which allow for the effluent to be contained and efficiently drawn up and evacuated from polishing pad surface 30 (shown by the arrows in FIG. 3). The evacuated effluent, in accordance with the present invention, is separated from the air stream and presented to an effluent analysis unit 50 for further characterization to create the feedback/feedforward process control signals. It is to be understood that in some embodiments, effluent analysis unit 50 may be disposed “in-line” along hose 46, as will be described in more detail below.

In general, these process control signals are shown as including: (1) CMP process signals (denoted “C”) related to endpoint detection, soft-landing, etc.; (2) effluent waste stream correction signals (denoted “W”) related to modifications to reduce environmental effects of effluent; and (3) process alarm signals (denoted “A”) related to malfunctions of various components of CMP system 11.

In contrast to the prior art, where only a sample of the effluent may be diverted for analysis purposes, the present invention requires the integration of a volume of evacuated effluent material, which is continuously metered and analyzed. By performing this type of volumetric analysis (i.e., effluent “fingerprinting”), changes in the effluent components can be used to determine planarization status and/or endpoint in real time so that a desired thickness of film material remains across the wafer surface. The first integral of the changes in effluent components may also be determined (i.e., providing a “rate of change”) and used for process control. Alternatively, a volume of collected effluent may be analyzed at known time intervals to generate characterization data for process control information.

Using an algorithmic determination of the total volume of removed film material, effluent analysis unit 50 is capable of performing a number of different characterizations to provide data useful in the adjustment of polishing head 10 (step, pressure, speed, zone pressure, potential and current (for eCMP)), polishing slurry 28 (chemical composition, flow rate, temperature) and conditioning agents 43 (chemical composition, flow rate, temperature). Modifications to the conditioning process (force, position) and waste stream disposal (pH adjustment, slurry recycle, water recycle) can also be performed. A significant aspect of the volumetric effluent analysis of the present invention resides in its ability to determine when the endpoint of a planarization step or process has been reached (particularly well-suited for blind steps—PMD or ILD CMP and bulk copper removal—before barrier/liner CMP step). Moreover, the volumetric analysis of the present invention, when applied in a continuous manner, provides in-situ monitoring and control of the removal rate of the target film. That is, by monitoring the concentration of the target film in the effluent in an on-going basis, the film's removal rate can be calculated and adjusted, if need be. The removal rate adjustment is particularly advantageous in creating a ‘soft-landing’ for Cu-overburden removal. In general, one or more of the materials used to perform the planarization and/or the applied downforce between the wafer and polishing pad can be controlled through feedback signals from effluent analysis unit 50 to control the removal rate. For example, a predicted removal rate (based on known input parameters) can be compared to the actual removal rate within analysis unit 50, and adjustments made to the process when a statistical difference is determined. In-situ monitoring and control of the target film's removal rate is thus considered to be a significant aspect of the present invention.

In accordance with the present invention, effluent analysis unit 50 may employ one or more of the following effluent analyses (which may be dependent on the composition of the film material being removed during planarization): (1) chemical (concentration, pH, ion selective electrode (ISE), infrared (IR) spectroscopy, acoustic analysis, RF/flux permeability; (2) tribological (viscosity); (3) physical (temperature, turbidity, particle morphology, refractive index); and/or (4) electrical (conductivity, capacitance, zeta potential, redox potential). The specifics of the type of analysis to be performed is dependent upon the composition of the film material being removed from the wafer surface and the chemical interaction of the slurry and conditioning agents, as well as the characteristics of the CMP equipment and the step-wise processes used to perform the actual planarization. It is to be understood that the present invention is not limited to any particular type of CMP equipment or process, but is generally useful in any system where the effluent can be collected and analyzed in a synchronized manner to control the overall process.

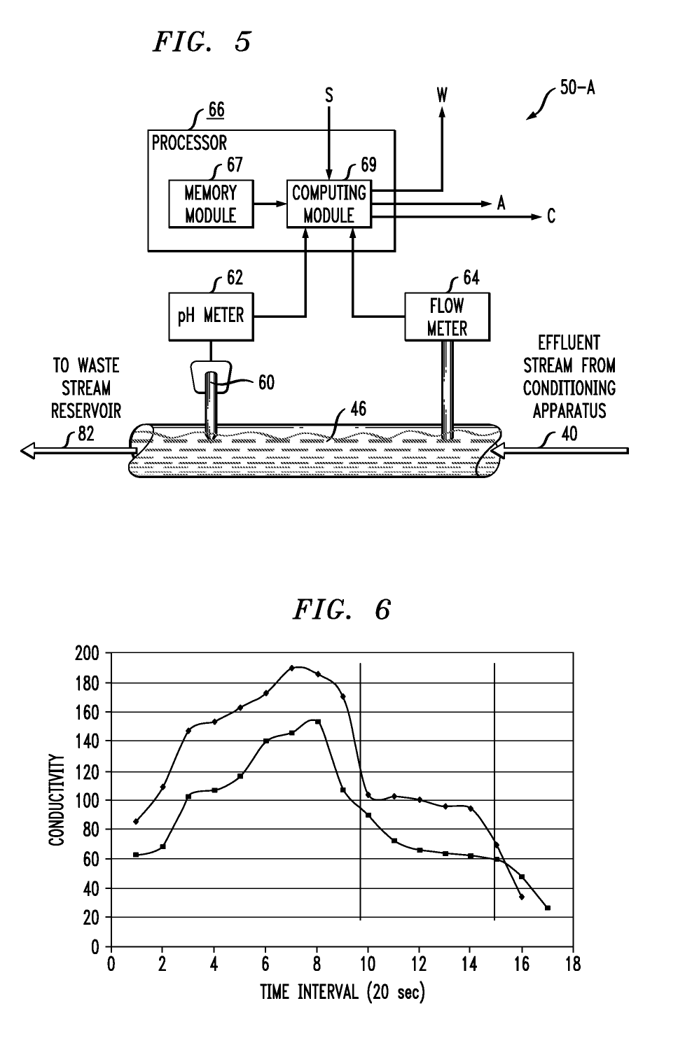

FIG. 5 illustrates an exemplary embodiment of a flow-based effluent analysis unit 50-A which may be used in the system of FIG. 3 to provide feedback and feedforward process control. In this case, a probe 60 is inserted directly into the effluent stream as it passes along hose 46 during evacuation from conditioning apparatus 40. In one embodiment, probe 60 may comprise an ion selective electrode (ISE) which is used to sample for specific ions. ISE probe 60 works with a pH meter 62 to determine an ion concentrations in ppm (typically a maximum of 5000 ppm). Presuming effluent analysis unit 50-A is being used in conjunction with a CMP process to remove overburden copper, a Cu-ion selective ISE probe 60 is used and the Cu-ion concentration in the effluent is measured. FIG. 6 contains plots of Cu-ion concentration in an effluent stream as a function of time, as measured during a Cu overburden removal process. Again, the use of an ISE probe as element 60 is considered to be exemplary only; various other types of probes may be used to measure various characteristics of the effluent, where the probe may be selected from the group consisting of, but not limited to, an ion-selective electrode, a spectroscopy cell, permeability cell, optical sensor, and a turbidity cell.

Referring again to FIG. 5, effluent analysis unit 50-A also includes a flow meter 64, which is inserted in the effluent stream within hose 46 and used to measure the effluent flow rate as a function of time. The outputs from pH meter 62 and flow meter 64 are thereafter applied as inputs to a processor 66. Processor 66 includes, for example, a memory module 67 (for storing set points and known system parameters such as film material thickness and composition, which may be input via an incoming “set” control signal (or signals) S from CMP apparatus 11) and a computing module 69 for integrating the incoming measurements and comparing with the values stored in memory module 67. In this particular embodiment, computing module 69 functions to integrate the ion concentration measurements over time and compare the result to the known value of the initial overburden thickness. By comparing these two values, computing module 69 can determine when then target copper overburden has been removed, allowing processor 66 to send a control signal C to CMP system 11 to stop the planarization process. In particular, the total moles removed copper can be expressed as follows:

$${mol}_{Cu} = {\int }_{T = 0}^{T = {T}_{final}} {\int }_{V = 0}^{V = {V}_{final}} [ Cu ] d V d T ,$$

which first integrates the concentration in a selected volume of the effluent, and then integrates all of the volumes over time to determine the total moles removed. The effluent flow rate is measured in ml/min at time T and the volume V of copper on the wafer is defined as thickness of the copper layer multiplied by the area of the wafer surface (the copper considered to uniformly coat the entire wafer surface). To obtain the volume of copper removed, the moles removed (as defined above) is multiplied by the specific volume of copper (measured in ml³/mole), which is equivalent to the atomic weight (AW) in grams/mole, divided by the density p of ECD copper metal in grams/ml³, or:

volume of copper removed=mol_{Cu}*(AW)/ρ.

It is an additional aspect of the present invention that any unusual or unexpected values in the concentration measurements (referred to as an “excursion”) can be used to trigger an excursion alarm signal A, alerting a CMP system user to a potential a process/equipment malfunction. It is to be understood that this specific implementation of processor 66 is exemplary only, various and other arrangements for performing the measurement, integration and analysis functions may be developed by those skilled in the art and are considered to fall within the spirit and scope of the present invention.

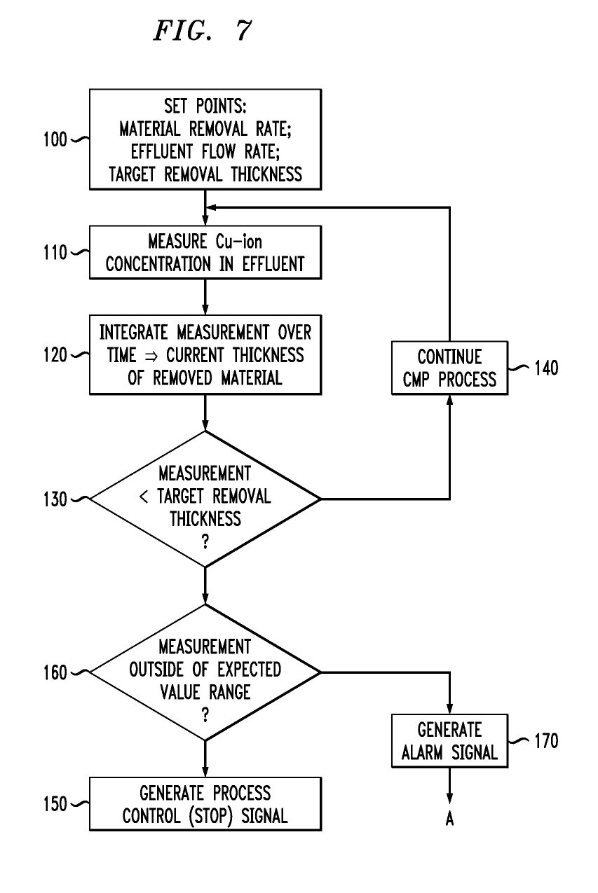

FIG. 7 is a flowchart illustrating an exemplary process as performed by flow-based effluent analysis unit 50-A. The process begins at step 100 by determining the various set points of the system. In this case, the effluent flow rate, film material composition, initial overburden thickness and target removal thickness are defined values. The effluent analysis process continues at step 110 by measuring the Cu-ion concentration in the flowing effluent stream. The measured values are then integrated over time, as shown in step 120, to generate a value associated with the removal rate and current thickness of copper that has been removed. In step 130, the result of the integral is compared against the known target removal thickness of the copper overburden. The result of this comparison is then used as a control signal, either permitting the planarization process to continue (if the target has not been reached), step 140, or sending a “stop” or “soft land” control signal C back to CMP system 11, step 150, when the desired amount of overburden has been removed (that is, when the integrated value of copper concentration equals the target removal thickness of the overburden material). It is to be understood that this signal can also be used to modify the planarization process, signaling the equipment to switch to a different soft landing or overburden removal procedure.

Additional process steps, related to recognizing an excursion alarm condition are included in the flowchart of FIG. 7. In this particular example, the measured value is compared against an “expected” value range (step 160) and any measurement outside the expected range is used to generate an alarm signal (step 170).

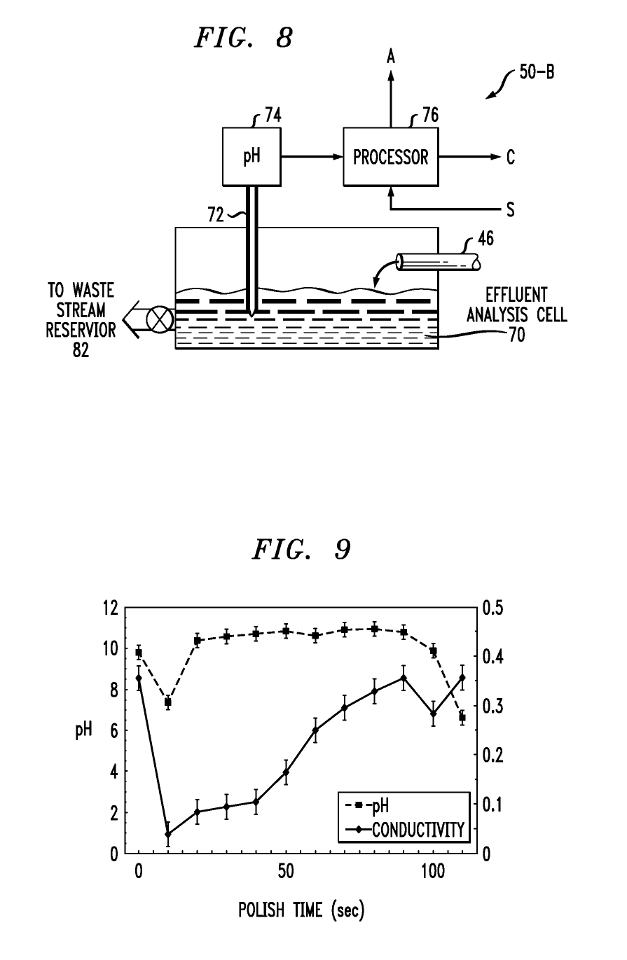

A volume-based embodiment 50-B of the effluent analysis unit of the present invention is shown in FIG. 8. In this case, a known volume of effluent is collected in an analysis cell 70. Presuming again that the CMP process is associated with copper overburden removal, the copper ion concentration can be measured by using an ISE probe 72 and pH meter 74 as discussed above. Inasmuch as CMP system 11 is calibrated to have a known removal rate as an initial set point value, the time interval required to remove the overburden can be determined within a processor 76 (where processor may comprise the memory and computing modules as described above). The polish time can therefore be controlled with a control signal C based on the integrated ISE signal for Cu-ion. Again, any unusual or unexpected measurements can be used to trigger an alarm signal for the CMP system operator.

For a dielectric polishing process (such as used with ILD CMP or PMD CMP), effluent analysis unit 50 of the present invention can perform conductivity measurements of the effluent, since silicon in solution will decrease the conductivity of the effluent. FIG. 9 is a graph plotting both pH and conductivity during a dielectric polishing process. Knowing the input feed rate(s) and/or effluent flow rate, the volume/unit time of effluent will also be known. A conductivity meter can be utilized within effluent analysis unit 50 and calibrated to determine the reading versus dissolved or entrained silica in solution, yielding a conductivity value. Similar to the overburden copper removal, to remove a known thickness of dielectric, the measured conductivity values are integrated over time. A concentration signal is derived from the conductivity signal, based on the calibration curve. These curves can be created during initial process development/qualification, with the “fingerprints” used as the “set” input control signals S to effluent analysis unit 50. This approach allows for more robust tuning and evolution of film materials/feature areas and volumes. Comparing this value to the known volume of dielectric to be removed, an endpoint control signal is generated and transmitted to CMP system 11 to halt (or soft land) the planarization process.

The arrangement of the present invention is thus able to provide real-time control of an on-going planarization process. That is, by analyzing the removed effluent (using any of the above-referenced or similar analysis methods), adjustments may be made to the planarization process in terms of, for example, removal rates (adjusting speeds, applied pressures, input flows, surface temperatures, etc.), removal selectivity of one material vs. another (adjusting incoming chemistry, solids concentration, abrasive size, slurry source, etc.), uniformity of removal over the wafer surface (adjusting rotation speed, pressures, chemical additions, neutralizers, etc.), and wafer surface conditions (e.g., particle affinity) by adjusting particle size, chemical activity, zeta potential, pH, corrosion inhibitors, head and zone pressures, potential, current, speeds, rinse agents, etc.

The system of the present invention can also apply feedforward techniques to learn from actual process metrology (e.g., film thickness, uniformity, film chemistry) or a device design evolution (feature size, density, materials, etc.) by accepting new fingerprints and adjusting control constants in the processing software. These adjustments and learnings are also useful aspects of the in-situ removal rate monitoring and control feature of the present invention, where modifications in removal rate as a function of one or more changes in input parameters may be stored and used in subsequent processes. (For example, historical analyses may find that the dielectric removal rate is impacted more by a change in particulate concentration than a change in slurry temperature).

Importantly, the feedforward signals can be effectively used to treat the effluent prior to releasing the flow into a waste stream. For example, by determining the pH of a known volume of effluent, a pH correction process may be applied to the effluent prior to discharge into a drain. FIG. 3 illustrates this aspect of the present invention, where effluent analysis unit 50 creates a waste stream control signal W, which is thereafter used by a waste correction unit 80 (such as a pH modifying element, a point-of-use abatement system, etc.) to adjust the parameters of a volume of effluent held in a reservoir 82, prior to discharge into a drain/waste stream. Indeed, it is possible to use this portion of the effluent analysis unit to treat and recycle the effluent (that is, separately recycling one or more of the polishing slurry, rinse water and conditioning agents), rather than discharge these materials into the waste stream. In one arrangement, the waste correction information developed by effluent analysis unit 50 may be provided as input signals to separate, external (to the CMP) treatment equipment which is capable of performing the treatments and recycling/discharge operations. Treatments may include, but are not limited to, separation, filtration, flocculation, precipitation, electroplating and the like. These and other treatments may allow for certain noxious components of the effluent to be removed from the waste stream, prevent chemical reactions among various waste stream components (perhaps from several, unrelated CMP processes, prevent coagulation/precipitation of the components during discharge, and the like. By treating the effluent stream prior to discharge, it is possible to reduce the amount of hazardous waste that is created, which aids the user in staying within government-regulated limits on discharge.

it is a further advantage of the volumetric effluent analysis process of the present invention that it may also sense film ‘volume’ differences between center and edge of the wafer. For example, by sensing the concentration of target material in the effluent, relative to pad position, it is possible to determine if there are global differences in concentration—attributable to radial non-uniformities across the polishing pad. The ability to sense these variations provides useful information regarding algorithmic constants, as well as process conditions such as pad wear, slurry distribution, non-uniform removal associated with CMP equipment problems, damage, etc., allowing the CMP system operator to better monitor the performance of the polishing interface. Depending upon the sensitivity of the measurement apparatus (i.e., if the signal-to-noise ratio is large enough), the concentration of the measured effluent component can be used to assess removal rate variations across the corresponding wafer radius. This ability to determine wafer-based differences in removal rate becomes even more interesting as larger wafers are used, where the feedback information from the effluent analysis unit can be tied to pressure zones within the polishing head.

While the invention has been described with regard to the preferred embodiments, it is to be understood by those skilled in the art that the invention is not limited thereof, and that changes and modifications may be made thereto without departing from the spirit and scope of the present invention as defined by the following claims.

What is claimed is:

1. A method of providing chemical mechanical planarization (CMP) process control, the method comprising the steps of:
a) continuously evacuating effluent from a CMP polishing pad surface during an on-going planarization process;
b) performing analyses of the evacuated effluent to measure at least one characterization parameter;
c) integrating the measured at least one characterization parameter over time to create volumetric result values; and
d) comparing the results of step c) with known initial conditions of the CMP process; and
e) generating at least one control signal associated with the on-going CMP planarization process.

2. The method as defined in claim 1 wherein in performing step b), the analyses are selected from the group consisting of: chemical, tribological, physical and electrical.

3. The method as defined in claim 2 wherein in performing step b), a chemical analysis is performed to determine the pH of the effluent stream.

4. The method as defined in claim 2 wherein in performing step b), a chemical analysis is performed to determine a concentration of a specific component in the effluent stream.

5. The method as defined in claim 2 wherein in performing step b), a tribological analysis is performed to determine the viscosity of the effluent stream.

6. The method as defined in claim 2 wherein in performing step b), a physical analysis is performed to determine the turbidity of the effluent stream.

7. The method as defined in claim 2 wherein in performing step b), an electrical analysis is performed to determine the conductivity of the effluent stream.

8. The method as defined in claim 1 wherein in performing step d), the known initial conditions include a chemical composition of a film material being removing during planarization, an initial thickness of the film material and a predetermined target removal thickness.

9. The method as defined in claim 1 wherein in performing step e), an endpoint control signal is generated and transmitted to the CMP processor to discontinue a planarization phase.

10. The method as defined in claim 9 wherein the endpoint control signal comprises a “stop planarization” control signal.

11. The method as defined in claim 9 wherein the endpoint control signal comprises a “soft landing” control signal.

12. The method as defined in claim 1 wherein in performing step e), an excursion alarm signal is generated.

13. The method as defined in claim 12 wherein the method further comprises the steps of:
1) comparing the results of step c) to a predefined range of acceptable values; and
2) generating an excursion alarm signal when the results of step c) are beyond the predefined range of acceptable values.

14. The method as defined in claim 1 wherein in performing step e), an effluent waste stream control signal is generated.

15. The method as defined in claim 14 wherein the method further comprises the steps of:
1) comparing the results of step c) to a predefined acceptable discharge stream value and, if the results of step c) differ therefrom;
2) determining a correction treatment suitable to conform the properties of the effluent stream to the predefined acceptable value; and
3) applying the treatment to the effluent stream.

16. The method as defined in claim 15 wherein in performing step 1) the pH of the effluent stream is measured and compared to a predefined acceptable pH value.

17. The method as defined in claim 15 wherein the method further comprises the step of discharging the treated effluent stream into a waste stream.

18. The method as defined in claim 15 wherein the method further comprises the step of recycling the treated effluent stream.

19. An effluent analysis unit for providing process control to a chemical mechanical planarization (CMP) process, the apparatus comprising:
an effluent evacuation path for removing effluent from a polishing pad during an on-going CMP planarization process;
an effluent analysis cell coupled to the effluent evacuation path for measuring at least one characteristic of the evacuated effluent; and
a processor, coupled to the effluent analysis cell for: integrating, over time, the measurements recorded by the effluent analysis cell to create volumetric analysis information; comparing the integrated result to a predetermined value; and generating at least one CMP process control signal based upon the comparison between the integrated result and the predetermined value.

20. An effluent analysis unit as defined in claim 19 wherein the effluent analysis cell is disposed in the effluent evacuation path and provides flow-based measurements of the effluent.

21. An effluent analysis unit as defined in claim 19 wherein the processor is coupled to a CMP tool for receiving and storing planarization process input data including the predetermined value of the at least characteristic of the CMP process.

22. An effluent analysis unit as defined in claim 19 wherein the analysis cell comprises a flow meter for measuring, as a function of time, the effluent flow rate, and at least one measurement probe for recording a property of the flowing effluent.

23. An effluent analysis unit as defined in claim 22 wherein the at least one measurement probe is selected from the group consisting of: an ion-selective electrode, a spectroscopy cell, permeability cell, optical sensor, and a turbidity cell.

24. An effluent analysis unit as defined in claim 18 wherein the analysis cell comprises a reservoir coupled to the effluent evacuation path for collecting a predetermined volume of effluent.

25. An effluent analysis unit as defined in claim 19 wherein the processor is configured to generate at least one control signal selected from the group consisting of: a CMP process control signal, a system excursion alarm signal and an effluent waste stream treatment signal.

26. An effluent analysis unit as defined in claim 25 wherein the CMP process control signal is a CMP endpoint control signal.

27. An effluent analysis unit as defined in claim 25 wherein the CMP process control signal is a process modification signal associated with soft landing or overpolish conditions.
